(19) United States
(12) Patent Application Publication
(10) Pub. No.: US 2016/0137875 A1
(43) Pub. Date: May 19, 2016

(54) CONDUCTIVE POLYMER COATING COMPOSITION

(71) Applicants: NITTO DENKO CORPORATION, OSAKA (JP); RICE UNIVERSITY, HOUSTON, TX (US)

(72) Inventors: Ruta KIBE, Osaka (JP); Takayuki YAMAMOTO, Osaka (JP); Laurent MAILLAUD, Houston, TX (US); Matteo PASQUALI, Houston, TX (US)

(73) Assignees: RICE UNIVERSITY, HOUSTON, TX (US); NITTO DENKO CORPORATION, OSAKA (JP)

(21) Appl. No.: 14/939,139

(22) Filed: Nov. 12, 2015

Related U.S. Application Data
(60) Provisional application No. 62/079,035, filed on Nov. 13, 2014.

(51) Int. Cl. C09D 141/00; C09D 5/24

(52) U.S. Cl. CPC C09D 141/00; C09D 5/24; C08K 5/42

(57) ABSTRACT

The present invention relates to a composition comprising a conductive polymer and a surfactant for forming a thin film on a substrate, and a method of manufacturing a thin film on a substrate, wherein the conductive polymer may comprise poly(3,4-ethlene-dioxythiophene)-poly(styrene sulfonate) (PEDOT-PSS).

### FIELD OF THE INVENTION

The present invention relates generally to a conductive polymer coating composition containing a conductive polymer and a surfactant for coating a substrate, and to a method of manufacturing the coating composition. The coating composition may further include carbon nanotubes. More specifically, the present invention relates to a coating composition that forms a transparent, flexible and conductive film on a substrate, and a method of manufacturing and forming the film on a substrate.

### BACKGROUND OF THE INVENTION

In the production of electrodes for the development of, for example, novel touch screens, photovoltaic panels and light-emitting diodes, the production of transparent, conductive and flexible electrodes is a major challenge because current technologies use costly and brittle inorganic oxides. For example, films formed from compositions containing inorganic oxides (such as indium tin oxide films) have good conductivity but are brittle and expensive to produce.

In order to overcome the problems of ITO films, conductive polymers have been used in coating compositions for providing, for example, films on electronic devices. Specifically, poly(3,4-ethlene-dioxythiophene)-poly(styrene sulfonate) (PEDOT-PSS) has been used as a transparent, conductive polymer for providing a film on flexible electronics since PEDOT-PSS has excellent flexibility and coatability.

In addition, carbon nanotubes are also viewed as potential alternatives to inorganic oxides in numerous applications, such as in the development of a coating composition for coating a substrate. Carbon nanotubes have optimal properties, such as high conductivity, high aspect ratio and high mechanical strength, for numerous applications. Since carbon nanotubes have a high aspect ratio and excellent mechanical and electrical properties, they can form conductive networks at low density on flexible surfaces and thus form a film that has an optimal balance of conductivity and optical transparency properties.

However, in the case of, for example, a coating composition containing PEDOT-PSS for coating a substrate, it is not possible to coat PEDOT-PSS in a water solution directly on, for example, a plastic film because the surface tension is too high (even if the viscosity is high). That is, a homogeneous film cannot be obtained due to high surface tension. In this regard, solvents such as isopropyl alcohol (IPA) or ethanol can be used to decrease surface tension. However, such solvents negatively affect the properties of PEDOT-PSS or affect the in-situ dopants, and lead to a decrease in conductivity. Accordingly, it is desired to obtain a film from a composition containing a conductive polymer such as PEDOT-PSS and a surfactant, such that the film can be homogenously applied on a substrate (such as a plastic substrate) without decreasing the properties of the film so that it has excellent flexibility and conductivity properties, good optical transparency and improved wettability characteristics.

In addition, in the case of, for example, a coating composition containing PEDOT-PSS with carbon nanotubes for coating a substrate, when a solvent is added into this mixture, carbon nanotubes were aggregated to the changing balance of the pH level and zeta potential in the dispersion. Existing compositions containing carbon nanotubes can be difficult to apply on substrates in the manufacturing process and may not be suitable for forming a homogenous film having a combination of desired properties. For example, when manufacturing a film using a carbon nanotube composition and sulfonic acid in a filtration process without the use of a surfactant, manufacturing equipment and materials may be damaged and a filtration process is difficult to apply in mass production. Further, due to the hydrophobic surface of carbon nanotubes, a surfactant is needed in order to disperse the carbon nanotubes. However, as another example, when manufacturing a film using a carbon nanotube composition and a surfactant, a homogenous film having good flexibility and conductivity can be formed but it may be difficult to remove the surfactant from the carbon nanotubes at the end of the manufacturing process. In addition, it is difficult to use a carbon nanotube composition to form a homogenous film having good wettability characteristics on a substrate, such as a plastic substrate. For example, when a carbon nanotube composition and a surfactant such as Triton™ X, sodium dodecylbenzene sulfonate (SDBS) or sodium deoxycholate (DOC) are used to form a film on a plastic substrate, these surfactants are unable to effectively lower the surface tension and thus fail to avoid dewetting effects. Accordingly, it is also desired to obtain a film from a composition containing a conductive polymer such as PEDOT-PSS, a surfactant and carbon nanotubes, such that the film can be homogenously applied on a substrate (such as a plastic substrate), the carbon nanotubes are not aggregated, and the film has excellent flexibility and conductivity properties, good optical transparency and improved wettability characteristics.

### SUMMARY OF THE INVENTION

The present invention is a composition comprising a conductive polymer and a surfactant, and a method of manufacturing a film on a substrate by using a composition comprising a conductive polymer and a surfactant. In the present invention, a film from a composition containing a conductive polymer and a surfactant can be obtained, and the film can be homogenously applied on a substrate (such as a plastic substrate) without decreasing the properties of the film. Thus, the resulting film has excellent flexibility and conductivity properties, good optical transparency and improved wettability characteristics.

In another embodiment, the present invention is a composition comprising a conductive polymer, carbon nanotubes and a surfactant, and a method of manufacturing a film on a substrate by using a composition comprising a conductive polymer, carbon nanotubes and a surfactant. In the present invention, the carbon nanotubes are dispersed well in the polymer (not aggregated) and the coating composition can be deposited as a thin film over a substrate, such as a plastic substrate, without dewetting effects. As a result, high performance transparent, flexible and conductive films can be formed on substrates.

In the present invention, the conductive polymer is preferably poly(3,4-ethlene-dioxythiophene)-poly(styrene sulfonate) (PEDOT-PSS).

Further, in the present invention, the surfactant is represented by the following Formula 1:

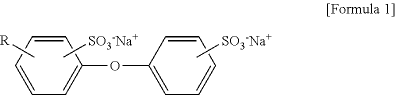

wherein R represents an alkyl group, such as a linear or branched alkyl group having 6 to 16 carbon atoms. Surfactants commercially sold as Dowfax™ (manufactured by The Dow Chemical Co.) can be used. Preferably, the surfactant is Dowfax™ 2 A1, which is commercially sold in order to provide good detergency. Preferably, the composition contains an amount of 0.04% wt. to less than 0.2% wt. of the surfactant.

In another aspect, the present invention provides a method of manufacturing a film on a substrate by using a composition comprising a conductive polymer and a surfactant, wherein the surfactant is represented by Formula 1. In one embodiment, the method for manufacturing the film comprises the steps of: mixing a surfactant represented by Formula 1 into water; adding the conductive polymer into the mixture; mixing the mixture of surfactant, water and conductive polymer; coating the resulting mixture on a substrate to obtain a liquid film on the substrate; and drying the film on the substrate.

In another aspect, the present invention provides a method of manufacturing a film on a substrate by using a composition comprising a conductive polymer, carbon nanotubes and a surfactant, wherein the surfactant is represented by Formula 1. In one embodiment, the method for manufacturing the film comprises the steps of: mixing a surfactant represented by Formula 1 into water; adding the conductive polymer into the mixture; adding carbon nanotubes into the mixture; sonicating the mixture of surfactant, conductive polymer, water and carbon nanotubes; centrifuging the resulting mixture; coating the resulting mixture on a substrate to obtain a liquid film on the substrate; and drying the film on the substrate.

Other features, objects, and advantages of the present invention are apparent in the detailed description that follows. It should be understood, however, that the detailed description, while indicating preferred embodiments of the invention, are given by way of illustration only, not limitation. Various changes and modifications within the scope of the invention will become apparent from the detailed description to those skilled in the art.

### BRIEF DESCRIPTION OF THE DRAWINGS

FIG. 1 is a chart showing the difference in effects (measured by FOM value, where FOM=−(Rs)*ln(T), Rs is sheet resistance and T is transmittance) when different amounts of the surfactant and conductive polymer (PEDOT-PSS) are used in the composition to form a film on a substrate.

FIG. 2 is a chart showing the difference in absorbance level at varying wavelengths when different compositions of conductive polymer and surfactant are used. The composition of PEDOT-PSS, carbon nanotubes and surfactant is represented by the blue line, the composition of PEDOT-PSS, carbon nanotubes and IPA solvent is represented by the red line, and the composition of PEDOT-PSS is represented by the green line.

### DETAILED DESCRIPTION OF THE INVENTION

It is to be understood that the present invention is not limited to the particular embodiments described, as such aspects may vary.

The composition of the present invention is a conductive polymer coating composition for forming a thin film to coat a substrate. The composition comprises a conductive polymer and a surfactant, wherein the surfactant is represented by Formula 1:

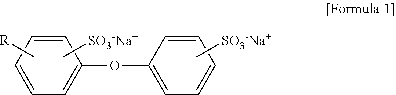

wherein R represents an alkyl group, such as a linear or branched alkyl group having 6 to 16 carbon atoms. In one embodiment, the composition comprises a conductive polymer, carbon nanotubes and a surfactant, wherein the surfactant is represented by Formula 1.

The conductive polymer is preferably poly(3,4-ethlene-dioxythiophene)-poly(styrene sulfonate) (PEDOT-PSS). Preferably, the composition contains an amount of 0.8 to 1.2% wt. of PEDOT-PSS. When the composition contains an amount of PEDOT-PSS that is below 0.8% wt., the viscosity would not be sufficiently high to allow an homogeneous deposition of conductive polymer on the plastic substrate. On the other hand, when the composition contains an amount of PEDOT-PSS that exceeds 1.2% wt., the concentration is too high and thus it would be difficult to form a transparent film having more than 90% of optical transmittance. In this case, a slot die coating method can be used to achieve a more homogeneous film.

The surfactant in the composition is used to obtain excellent wettability characteristics for the film that is coated on the substrate and for dispersing the carbon nanotubes. Surfactants commercially sold as Dowfax™ (manufactured by The Dow Chemical Co.) can be used. Preferably, the surfactant is commercially sold as Dowfax™ 2 A1 in order to provide good detergency. When the composition containing Dowfax™ 2 A1 as the surfactant is coated on a plastic substrate, surface tension is effectively minimized such that there are no dewetting effects.

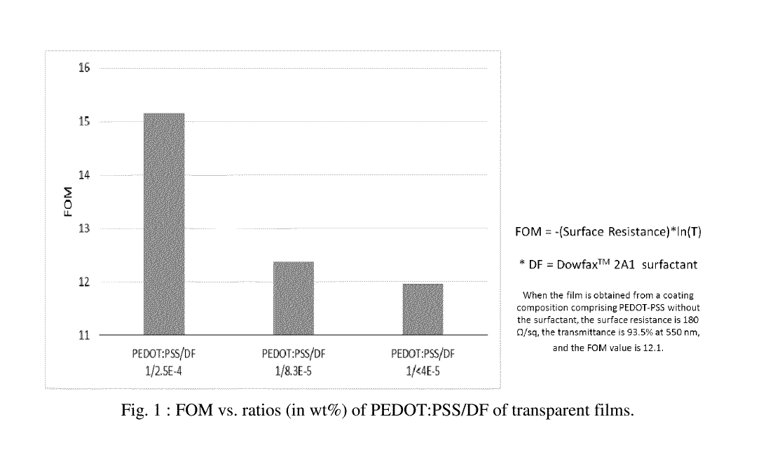

Preferably, the composition contains a small amount of the surfactant in order to coat the composition on the substrate without decreasing the properties of the conductive polymer and to avoid having too much surfactant remaining on the final dried film that is coated on the substrate. Specifically, the composition preferably contains an amount of 2×10⁻⁵% wt. to less than 0.2% wt. of the surfactant. When the composition contains an amount of 2×10⁻⁵% wt. to less than 0.2% wt. of the surfactant, the surfactant can form a homogenous film on the substrate and disperse the carbon nanotubes well. However, when the composition contains an amount of surfactant that is below 2×10⁻⁵% wt., the amount of surfactant is not sufficient for forming a homogenous film on the substrate (the amount of surfactant is not sufficient for obtaining a good viscosity and surface tension). Further, when the composition contains an amount of surfactant that is 0.2% wt. or more, the electrical properties of films are deteriorated (see, for example, FIG. 1) due to an excess of isolative surfactant. In addition, when the composition contains too much surfactant, the surfactant may initiate too many interactions (depletion interactions) with the carbon nanotubes, which leads to undesired carbon nanotube aggregation.

As shown in FIG. 1, when the amount of surfactant used in the composition to coat a substrate is lowered, the FOM value (where FOM=−(Rs)*ln(T) and T is transmittance) is lower, thus resulting in, for example, enhanced electrical conductivity.

The carbon nanotubes in the composition are not particularly limited. For example, single-wall carbon nanotubes, double-wall carbon nanotubes, triple-wall carbon nanotubes and multi-wall carbon nanotubes may be used. Single-wall carbon nanotubes are most preferably used to form transparent and conductive films. For example, SWNT eDIPS EC 2.0 carbon nanotubes (manufactured by Meijo Nano Carbon Co., Ltd.), which contains mainly single-wall carbon nanotubes but may also include double-wall and triple-wall carbon nanotubes, may be used. Preferably, the carbon nanotubes have a diameter of 0.8 nm to 3 nm and a length of 0.5 μm to more than 10 μm. The physical dimensions of the carbon nanotubes are preferably the smallest diameter combined with the longest length. In addition, high quality carbon nanotubes (for example, having a G/D ratio larger than 35) are preferably used. The composition preferably contains an amount of 0.01% wt. to 5% wt. of carbon nanotubes, more preferably an amount of 0.05% wt. to 0.2% wt. of carbon nanotubes.

The range of the weight ratio of conductive polymer to surfactant in the composition is preferably 1:0.2 to 1:2×10⁻⁵. The weight ratio of conductive polymer to surfactant in the composition is more preferably 1:1×10⁻⁴ to 1:2×10⁻⁵. When the weight ratio is below 1:2×10⁻⁵, the amount of surfactant is not sufficient for forming a homogenous film on the substrate (that is, the amount of surfactant is not sufficient for obtaining a good viscosity and surface tension). Further, when the weight ratio exceeds 1:1×10⁻⁴, the electrical properties of films are deteriorated (see, for example, FIG. 1) due to an excess of isolative surfactant. A weight ratio of conductive polymer to surfactant in the composition is preferably 1:2×10⁻⁵, where the surfactant is Dowfax™ 2 A1.

Further, the range of the weight ratio of conductive polymer to carbon nanotubes to surfactant in the composition is preferably 0.2/0.01/0.01 to 1.5/0.1/0.2. The weight ratio of conductive polymer to carbon nanotubes to surfactant in the composition is more preferably 0.5/0.05/0.02 to 1/0.1/0.05. When the weight ratio is 0.2/0.01/0.01 to 1.5/0.1/0.2, the surfactant can disperse the carbon nanotubes well and form a homogeneous film. However, when the weight ratio is below 0.2/0.01/0.01, the amount of surfactant is not sufficient for forming a homogenous film on the substrate (the amount of surfactant is not sufficient for obtaining a good viscosity and surface tension). Further, when the weight ratio exceeds 1.5/0.1/0.2, the surfactant may initiate too many interactions (depletion interactions) with the carbon nanotube, which leads to undesired carbon nanotube aggregation.

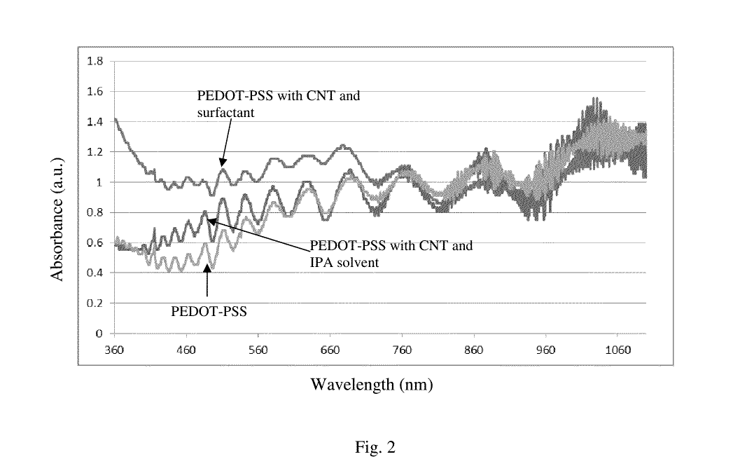

As shown in FIG. 2, when the film is obtained from a composition containing only PEDOT-PSS, the absorbance at short wavelengths is at low level since there is no carbon nanotubes. When the film is obtained from a composition containing PEDOT-PSS, carbon nanotubes and IPA solvent, the absorbance at short wavelength is still at a low level since the IPA solvent lead to carbon nanotubes aggregation due to the changing balance of the pH level and zeta potential in the dispersion. On the other hand, when the film is obtained from a composition containing PEDOT-PSS, carbon nanotubes and Dowfax™ 2 A1, the absorbance at short wavelengths is at a higher level since the carbon nanotubes are dispersed well and the resulting film is homogenously formed on the substrate.

The substrate is not particularly limited. A transparent and conductive film formed using an embodiment of the method of the present invention may be applied to any article having a rigid or flexible substrate, and the substrate may be transparent, translucent, opaque or colored. The substrate can be a metal, glass or plastic substrate. Preferably, the substrate is a plastic substrate since a plastic substrate is more flexible. Among plastic substrates, polymeric substrates are preferred because of their compatibility with transparent and conductive films and ease of use. The polymeric substrates are chosen depending on the properties required by the final application (such as being held at elevated temperatures and resistance to aging). Thus, the flexible polymeric substrates are preferably selected from polyethylene terephthalate (PET), polyethylene naphthalate (PEN), polyethersulfone (PES), polycarbonate (PC), polysulfone (PSU), phenolic resins, epoxies, polyesters, polyimides, polyether esters, polyether amides, polyvinyl (acetate), cellulose nitrate, cellulose acetate, polystyrene, polyolefins, polyamide, aliphatic polyurethanes, polyacrylonitrile, polytetrafluoroethylene (PTFE), polymethyl methacrylate (PMMA), polyarylate, polyether imides, polyether ketones (PEK), the polyether ether ketones (PEEK) and polyvinylidene fluoride (PVDF). Most preferably, the substrate is a flexible polymeric substrate selected from polyethylene terephthalate (PET), polyethylene naphthalate (PEN) and polyether sulfone (PES) substrates.

In one aspect, the present invention provides a method of manufacturing a film on a substrate by using a composition comprising a conductive polymer and a surfactant, wherein the surfactant is represented by Formula 1. In one embodiment, the method for manufacturing the film comprises the steps of: mixing a surfactant represented by Formula 1 into water; adding the conductive polymer into the mixture; sonicating the mixture of surfactant, water and conductive polymer; centrifuging the resulting mixture; coating the resulting mixture on a substrate to obtain a liquid film on the substrate; and drying the film on the substrate.

In one aspect, in the method for manufacturing a film on a substrate of the present invention, an aqueous dispersion containing the composition comprising a conductive polymer, carbon nanotubes and a surfactant is formed. In the aqueous dispersion, the carbon nanotubes are as individualized as possible in order to form the most homogeneous transparent film. Further, other substances, such as nano silica, metal particles or a conductive polymer, may be added to aqueous dispersion in order to improve conductivity and transparency.

In one embodiment, the method for manufacturing a film on a substrate comprises the steps of: mixing a surfactant represented by the Formula 1 into distilled water; adding the conductive polymer into the mixture; adding carbon nanotubes into the mixture; sonicating the mixture of conductive polymer, surfactant, water and carbon nanotubes; centrifuging the resulting mixture; coating the resulting mixture on a substrate to obtain a liquid film on the substrate; and drying the film on the substrate.

In one aspect, in the method for manufacturing a film on a substrate, an amount of the surfactant and an amount of conductive polymer are included in the composition, such that the range of the weight ratio of conductive polymer to surfactant in the composition is preferably 1:0.2 to 1:2×10⁻⁵. The weight ratio of conductive polymer to surfactant in the composition is more preferably 1:1×10⁻⁴ to 1:2×10⁻⁵.

In one aspect, in the method for manufacturing a film on a substrate, an amount of the surfactant, an amount of carbon nanotubes and an amount of conductive polymer are included in the composition, such that the range of the weight ratio of conductive polymer to carbon nanotubes to surfactant in the composition is preferably 0.2/0.01/0.01 to 1.5/0.1/0.2. The weight ratio of conductive polymer to carbon nanotubes to surfactant in the composition is more preferably 0.5/0.05/0.02 to 1/0.1/0.05.

In the coating step, the resulting mixture is deposited on the substrate as a thin homogenous film. The film deposited on the substrate has a thickness of 10 nm to 2 μm. The method of the film deposition is not particularly limited. For example, the film may be deposited on the substrate using a method such as a Mayer rod coating method, a slot-die coating method, spray or gravure.

In the drying step, the liquid film may be dried in an oven. For example, the liquid film may be dried in an oven at a temperature of 90° C. for 15 minutes. In one embodiment, the liquid film may be dried in a first drying step, subjected to a water washing step, and then dried in a second drying step.

The film that is formed on the substrate has excellent flexibility and conductivity properties, good optical transparency and excellent wettability characteristics. In particular, when the film is formed on a plastic substrate by using Dowfax™ 2 A1 as the surfactant, surface tension is effectively minimized such that there are no dewetting effects.

### Example 1

A conductive polymer coating composition is prepared by mixing 2 μL of an aqueous solution of Dowfax™ 2 A1 (manufactured by The Dow Chemical Co.) with a solid content of 48% and 5 mL of a solution of PEDOT-PSS (Orgacon™ HIL-1005, manufactured by Agfa) with a solid content of 1% using a magnetic stifling bar. The resulting composition prepared has a weight ratio of PEDOT-PSS to Dowfax™ 2 A1 of 1:2×10⁻⁵. The surfactant concentration in the composition is 2×10⁻⁵% wt.

The resulting liquid composition is deposited on a transparent plastic film by using a rod coating machine to form a liquid film on the transparent plastic film. The liquid film is dried in an oven for 15 minutes at a temperature of 90° C. The resulting transparent film has a surface resistance Rs of 226 Ω/sq and a transmittance T of 94.8% at 550 nm.

The foregoing description of the present invention provides illustration and description, but is not intended to be exhaustive or to limit the invention to the precise one disclosed. Modifications and variations are possible in light of the above teachings or may be acquired from practice of the invention. Thus, it is noted that the scope of the invention is defined by the claims and their equivalents.

What is claimed is:

1. A composition comprising a conductive polymer and a surfactant.

2. The composition according to claim 1, further comprising carbon nanotubes.

3. A method of manufacturing a film on a substrate by using a composition comprising a conductive polymer and a surfactant.

4. A method of manufacturing a film on a substrate by using a composition comprising a conductive polymer, carbon nanotubes and a surfactant.

5. A film manufactured on a substrate by using the method of claim 3.

6. A film manufactured on a substrate by using the method of claim 4.
